(19) United States
(12) Patent Application Publication
(10) Pub. No.: US 2022/0340734 A1
(43) Pub. Date: Oct. 27, 2022

(54) POLYOLEFIN COMPOSITIONS AND METHODS FOR MAKING THE SAME

(71) Applicant: Momentive Performance Materials Inc., Waterford, NY (US)

(72) Inventors: Cheng Diao, White Plains, NY (US); Monjit Phukan, West Harrison, NY (US); Neal Patel, Nyack, NY (US); Qian Wu, Shanghai (CN)

(21) Appl. No.: 17/730,456

(22) Filed: Apr. 27, 2022

Related U.S. Application Data
(60) Provisional application No. 63/180,265, filed on Apr. 27, 2021.

(51) Int. Cl. C08K 9/06; C08K 3/36; C08K 5/54

(52) U.S. Cl. CPC C08K 9/06; C08K 3/36; C08K 5/5406

(57) ABSTRACT

A polyolefin composition is shown and described herein. The polyolefin composition is a composition comprising a polyolefin resin and a filler where the filler is treated with an acrylic functional silane. Employing a filler treated with an acrylic functional silane may allow for eliminating some common polyolefins reinforcing additives such as modified or grafted polyolefins. The composition can be employed to make a molded article.

### CROSS-REFERENCE TO RELATED APPLICATIONS

This application claims priority to and the benefit of U.S. Provisional Patent Application 63/180,265, titled “POLYOLEFIN COMPOSITIONS AND METHODS FOR MAKING THE SAME” filed on Apr. 27, 2021, the disclosure of which is incorporated herein by reference in its entirety.

### FIELD OF INVENTION

The present invention relates to a reinforced polyolefin composition. In particular, the present invention relates to a polyolefin resin composition reinforced with a filler that has been treated with an acrylic functionalized silane. The present invention also relates to methods of making such compositions and making a molded article from such compositions.

### BACKGROUND

Polyolefin materials such as polypropylene are widely used to produce molded articles due to their excellent physical properties, moldability, and recyclability. Polyolefin materials are generally low polarity materials, which can be beneficial in a variety of applications. While possessing these properties, polyolefins also tend to exhibit high plasticity. As such, polyolefins must typically be reinforced in order to produce materials having a suitable or desired structural strength during formation or for the end product being produced. Polyolefins are often reinforced with a filler such as glass fiber, silica, talc, and the like, to provide the desired structural properties. Polyolefins are also generally chemically inert, which makes functionalizing and crosslinking polyolefins difficult.

To address these various issues with polyolefins, the conventional practice in the industry is to reinforce polyolefins with a filler treated with or functionalized with an amino silane. Polyolefins, especially high molecular weight polyolefins, tend to degrade into lower molecular weight chains during processing. The inherent non-polar and non-reactive nature of polyolefins makes it difficult for aminosilane treated fillers to bond with the polyolefin and the free radical species produced through degradation of the polyolefin. To overcome this issue, anhydride grafted polypropylene is used as an additive in polyolefin processing to facilitate development of interfacial bonding. Use of anhydride grafted polypropylene increases the cost associated with producing the reinforced polyolefins and requires more complex processing to produce such materials. Other grafted polyolefins have also been used to reinforce polyolefin materials. Compositions that employ grafted polyolefins often involve complex formulations and may need co-agents or other materials to prevent polymer degradation. Accordingly, there is a need for improved reinforced polyolefins that overcome the deficiencies of conventional reinforced polyolefins, particularly those that are prepared with aminosilane functionalized fillers and anhydride grafted-polyolefins.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

The present invention relates to a polyolefin composition reinforced with a filler treated with an acrylic functional silane. The compositions made with the present acrylic functional silane treated fillers exhibit improved mechanical performance such as improved tensile strength and impact strength compared to conventional reinforced polyolefins that are prepared with aminosilane functionalized fillers and grafted-polyolefins (e.g., polyolefins grafted with anhydride, silanes, and the like) along with other additives. Additionally, the present invention provides easier processing of the compositions and provides compositions with low odor (compared to amino functionalized fillers) and improved color resistance compared to the polyolefin composite materials produced with the conventional amino silane treated fillers.

In a first embodiment, provided is a polyolefin composition comprising (i) a polyolefin resin, and (ii) a filler treated with an acrylic functional silane.

In a second embodiment, the acrylic functional silane comprises at least one of an acryloxy functional silane, an acrylamido functional silane, or a combination thereof.

In a third embodiment provided is a polyolefin composition comprising (i) a polyolefin resin, and (ii) a filler treated with an acrylic functional silane, wherein the acrylic functional silane is of the formula:

CH₂═CH—C(O)—X—R¹—Si—R²(R³)_{3-b}

where:

### X is O or N(R⁴);

R¹ is independently a divalent group selected from straight chain alkyl containing from 1 to 20 carbon atoms, a branched chain alkyl containing from 3 to 20 carbon atoms, a cycloalkyl containing from 5 to 20 carbon atoms, an alkenyl containing from 2 to 20 carbon atoms, an aryl group containing from 6 to 20 carbon atoms or aralkyl containing from 7 to 20 carbon atoms;
R² is (OR⁵)_{b} where R⁵ is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl containing from 2 to 12 carbon atoms, an aryl group containing 6 carbon atoms, or aralkyl containing from 7 to 12 carbon atoms, a straight chain alkyl containing 2 to 12 carbon atoms and a hydroxyl group or a branched chain alkyl containing 3 to 6 carbon atoms and a hydroxyl group, an alkyl group containing at least one oxygen atom having the structure —R⁶—(OCH₂CH₂)ₘ(OCH₂CH(CH₃))ₙOR⁷ or is a divalent group formed from two R⁵ groups being bonded together through a covalent bond, with the provisos that (i) if two R⁵ groups are bonded together, then b is 2 or 3 and (ii) the sum of m+n is from 1 to 20;
b is 1, 2, or 3;
each R³ is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl group containing from 2 to 12 carbon atoms, an aryl group containing 6 carbon atoms or aralkyl group containing from 7 to 12 carbon atoms;
R⁴ is independently H, is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl group containing from 2 to 12 carbon atoms, an aryl group containing 6 carbon atoms or aralkyl group containing from 7 to 12 carbon atoms;
R⁶ is divalent group selected from straight chain alkyl containing from 1 to 10 carbon atoms, a branched chain alkyl containing from 3 to 10 carbon atoms, a cycloalkyl containing from 5 to 10 carbon atoms;
R⁷ is a monovalent group selected from straight chain alkyl containing from 1 to 18 carbon atoms, a branched chain alkyl containing from 3 to 18 carbon atoms, a cycloalkyl containing from 5 to 18 carbon atoms, an alkenyl containing from 2 to 18 carbon atoms, an aryl group containing from 6 to 18 carbon atoms, aralkyl containing from 7 to 18 carbon atoms or hydrogen, or is a divalent group selected from an alkyl containing from 1 to 10 carbon atoms, a cycloalkyl containing from 5 to 10 carbon atoms or phenyl;
wherein the composition is free of a polyolefin additive having a functional group bonded to a polyolefin.

In a fourth embodiment in accordance with the third embodiment, the filler treated with an acrylic functional silane comprises the acrylic functional silane in an amount of from about 0.01 wt. % to about 20 wt. % based on the total weight of the filler.

In a fifth embodiment in accordance with the third or fourth embodiment, the filler treated with an acrylic functional silane comprises the acrylic functional silane in an amount of from about 1 wt. % to about 7.5 wt. % based on the total weight of the filler

In a sixth embodiment in accordance with any of the third through fifth embodiments, the filler treated with an acrylic functional silane comprises the acrylic functional silane in an amount of from about 2 wt. % to about 5 wt. % based on the total weight of the filler

In a seventh embodiment in accordance with any of the third through sixth embodiments, the filler is selected from at least one of titanium dioxide, aluminium trihydroxide, magnesium dihydroxide, mica, kaolin, calcium carbonate, non-hydrated, partially hydrated, or hydrated fluorides, chlorides, bromides, iodides, chromates, carbonates, hydroxides, phosphates, hydrogen phosphates, nitrates, oxides, and sulphates of sodium, potassium, magnesium, calcium, and barium; zinc oxide, aluminium oxide, antimony pentoxide, antimony trioxide, beryllium oxide, chromium oxide, iron oxide, lithopone, boric acid or a borate salt such as zinc borate, barium metaborate or aluminium borate, mixed metal oxides such as aluminosilicate, vermiculite, silica including fumed silica, fused silica, precipitated silica, quartz, sand, and silica gel; rice hull ash, ceramic and glass beads, zeolites, metals such as aluminium flakes or powder, bronze powder, copper, gold, molybdenum, nickel, silver powder or flakes, stainless steel powder, tungsten, hydrous calcium silicate, barium titanate, silica-carbon black composite, functionalized carbon nanotubes, cement, fly ash, slate flour, bentonite, clay, talc, anthracite, apatite, attapulgite, boron nitride, cristobalite, diatomaceous earth, dolomite, ferrite, feldspar, graphite, graphene, carbon fiber, calcined kaolin, molybdenum disulfide, perlite, pumice, pyrophyllite, sepiolite, zinc stannate, zinc sulfide or wollastonite, wood flour, wood fibers, cotton fibers, wheat straw, hemp, flax, kenaf, kapok, jute, ramie, sisal, henequen, corn fibre or coir, or nut shells or rice hulls, polyester fibers, aramid fibers, nylon fibers, glass fibers, lignin, starch, cellulose or cellulose-containing products, plastic microspheres of polytetrafluoroethylene or polyethylene, azo dyes, indigoid dyes, triphenylmethane dyes, anthraquinone dyes, hydroquinone dyes, or xanthine dyes.

In a eighth embodiment in accordance with any of the third through seventh embodiments, the filler is selected from calcium hydroxide, barium sulfate, mica, calcium silicate, clay, kaolin, silica, alumina, wollastonite, magnesium carbonate, magnesium hydroxide, titanium oxide, zinc oxide, zinc sulfate, or a combination of two or more thereof.

In an ninth embodiment in accordance with any of the third through eighth embodiments, the filler is selected from silica.

In a tenth embodiment in accordance with any of the third through ninth embodiments, the filler treated with an acrylic functional silane is present in an amount of from about 0.01 wt. % to about 99 wt. % based on the total weight of the polyolefin composition.

In a eleventh embodiment in accordance with any of the third through tenth embodiments, the filler treated with an acrylic functional silane is present in an amount of from about 20 wt. % to about 50 wt. % based on the total weight of the polyolefin composition.

In an twelfth embodiment in accordance with any of the third through eleventh embodiments, the polyolefin is selected from a polymer of an olefin having from 2 to 18 carbon atoms.

In a thirteenth embodiment in accordance with any of the third through twelfth embodiments, the polyolefin is selected from a polypropylene, a polyethylene, polybutylene, or a mixture of two or more thereof.

In a fourteenth embodiment in accordance with any of the third through thirteenth embodiments, the polyolefin is present in an amount of from about 10 wt. % to about 99.9 wt. % based on the total weight of the polyolefin composition.

In a fifteenth embodiment in accordance with any of the third through fourteenth embodiments, the composition further comprises (iii) a silane additive.

In a sixteenth embodiment in accordance with any of the third through fifteenth embodiments, the silane additive is selected from an acrylic functional silane selected from an acrlyoxy functional silane, an acrylamido functional silane, or a combination thereof.

In a seventeenth embodiment in accordance with any of the fifteenth or sixteenth embodiments, the silane additive (iii) is of the formula:

CH₂═CH—C(O)—X′—R^{1′}—Si—R^{2′}(R^{3′})_{3-b′}

where:

### X′ is O or N(R^{4′});

R^{1′} is independently a divalent group selected from straight chain alkyl containing from 1 to 10 carbon atoms, a branched chain alkyl containing from 3 to 10 carbon atoms, a cycloalkyl containing from 5 to 10 carbon atoms, an alkenyl containing from 2 to 10 carbon atoms, an aryl containing from 6 to 10 carbon atoms or aralkyl containing from 7 to 10 carbon atoms;
R^{2′} is (OR^{5′})_{b′} where R^{5′} is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl containing from 2 to 12 carbon atoms, an aryl containing 6 carbon atoms, aralkyl containing from 7 to 12 carbon atoms, a straight chain alkyl containing 2 to 12 carbon atoms and a hydroxyl or a branched chain alkyl containing 3 to 6 carbon atoms and a hydroxyl, or an alkyl containing at least one oxygen atom having the structure —R^{6′}—(OCH₂CH₂)_{m′}(OCH₂CH(CH₃))_{n′}OR^{7′} or is a divalent group formed from two R^{5′} groups being bonded together through a covalent bond, with the provisos that (i) if two R^{5′} groups are bonded together, then b is 2 or 3 and (ii) the sum of m′+n′ is from 1 to 20;
b′ is 1, 2, or 3;
each R^{3′} is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl containing from 2 to 12 carbon atoms, an aryl containing 6 carbon atoms or aralkyl containing from 7 to 12 carbon atoms;
R^{4′} is independently H, is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl containing from 2 to 12 carbon atoms, an aryl containing 6 carbon atoms or aralkyl containing from 7 to 12 carbon atoms;
R^{6′} is divalent group selected from straight chain alkyl containing from 1 to 10 carbon atoms, a branched chain alkyl containing from 3 to 10 carbon atoms, a cycloalkyl containing from 5 to 10 carbon atoms;
R^{7′} is a monovalent group selected from straight chain alkyl containing from 1 to 18 carbon atoms, a branched chain alkyl containing from 3 to 18 carbon atoms, a cycloalkyl containing from 5 to 18 carbon atoms, an alkenyl containing from 2 to 18 carbon atoms, an aryl containing from 6 to 18 carbon atoms, aralkyl containing from 7 to 18 carbon atoms or hydrogen, or is a divalent group selected from an alkyl containing from 1 to 10 carbon atoms, a cycloalkyl containing from 5 to 10 carbon atoms or phenyl.

In an eighteenth embodiment in accordance with any of the third through seventeenth embodiments, the composition is in the form of a pellet or particle.

In a nineteenth embodiment in accordance with any of the third through eighteenth embodiments, the composition consists essentially of the polyolefin resin (i), the filler treated with an acrylic functional silane (ii), and optionally the silane additive (iii).

In a twentieth embodiment in accordance with any of the third through nineteenth embodiments, the composition further comprises at least one additive selected from a peroxide, an antioxidant, a lubricant, a pigment, or a combination of two or more thereof.

In a twenty-first embodiment embodiments, provided is molded article formed from the polyolefin composition in accordance with any of the third through twentieth embodiments.

In a twenty-second embodiment, provided is a method of making a molded article comprising extruding the polyolefin composition of any of the third through twentieth embodiments.

In a twenty-third embodiment, provided is a method of making a polyolefin composition of any of the third through twentieth embodiments comprising: compounding a polyolefin with a filler treated with an acrylic functional silane.

The following description and the drawings disclose various illustrative aspects. Some improvements and novel aspects may be expressly identified, while others may be apparent from the description and drawings.

### BRIEF DESCRIPTION OF THE DRAWINGS

The accompanying drawings illustrate various systems, apparatuses, devices and related methods, in which like reference characters refer to like parts throughout, and in which:

FIG. 1 is a graph showing the tensile strength and strain of polyolefin composite materials in accordance with embodiments of the present invention compared to a conventional polyolefin formulation;

FIG. 2 is a graph showing the impact properties of polyolefin compositions in accordance with embodiments of the present invention compared to a conventional polyolefin formulation; and

FIG. 3 is a graph showing the impact properties of polyolefin compositions in accordance with embodiments of the present invention compared to conventional polyolefin formulations.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Where ranges are presented or discussed with respect to a particular component, it will be appreciated that the ranges include new and non-specified ranges based on the endpoints of the described ranges.

Provided is a polyolefin composition. The polyolefin composition includes a filler that has been treated with an acrylic functional silane. The polyolefin compositions can be utilized to form polyolefin composite materials. The polyolefin compositions can be utilized to form a molded article. The polyolefin composition may also be referred to herein as a composite composition, a polyolefin composite, or a polyolefin composite composition. A composite includes at least one polymer matrix or material in combination with at least one particulate filler material.

### Polyolefin

The polyolefin is not particularly limited and can be selected as desired for a particular purpose or intended application. In an embodiment, the polyolefin may be a polymer of an olefin having 2 to 18 carbon atoms such as an alpha-olefin of the formula CH₂═CHQ where Q is H or a linear or branched alkyl group having 1 to 16, more preferably 1 to 8 carbon atoms. The polyolefin can for example be a polymer of ethene (ethylene), propene (propylene), 1-butene, 1-hexene, 1-octene, 4-methyl-pentene-1 or 2-methyl-propene-1 (isobutylene), and the like. The form of the polyolefin is not particularly limited. In embodiments, the polyolefin can be an isotactic, syndiotactic, or atactic polyolefin. Additionally, the polyolefin can be a homopolymer, a co-polymer of two or more polyolefins, a terpolymer, etc.

In one embodiment, the polyolefin is a polypropylene. Polypropylene is a well-known polymer that has low density and is easily processed and versatile. Most commercially available polypropylene is isotactic polypropylene, but atactic and syndiotactic polypropylene can also be used. Isotactic is prepared for example by polymerization of propene using a Ziegler-Natta catalyst or a metallocene catalyst.

The polyolefin can alternatively be a polymer of a diene, such as a diene having 4 to 18 carbon atoms and at least one terminal double bond, for example butadiene or isoprene. The polyolefin can be a copolymer or terpolymer, particularly a copolymer or terpolymer comprising at least 50% by weight units of an olefin having 3 to 18 carbon atoms, for example a copolymer of at least 50% by weight propylene with ethylene or an alpha-olefin having 4 to 18 carbon atoms, or with an acrylic monomer such as acrylic acid, methacrylic acid, acrylonitrile, methacrylonitrile or an ester of acrylic or methacrylic acid and an alkyl or substituted alkyl group having 1 to 16 carbon atoms, for example ethyl acrylate, methyl acrylate or butyl acrylate, or a copolymer with vinyl acetate. The polyolefin can be a terpolymer for example a propylene ethylene diene terpolymer. Alternatively, the polyolefin can be a diene polymer such as polybutadiene, polyisoprene or a copolymer of butadiene with styrene, or a terpolymer of butadiene with ethylene and styrene or with acrylonitrile and styrene. The polyolefin can be heterophasic, for example a propylene ethylene block copolymer.

The polyolefin is present in the composition in any amount as desired for a particular purpose or intended application. In one embodiment, the polyolefin is present in an amount of from about 10 wt. % to about 99.9 wt. %, from about 15 wt. % to about 95 wt. %, from about 20 wt. % to about 90 wt. %, from about 25 wt. % to about 80 wt. %, from about 30 wt. % to about 75 wt. %, or from about 40 wt. % to about 60 wt. %, based on the total weight of the composition.

### Filler

The filler comprises a filler material treated with an acrylic functional silane. The filler material is not particularly limited and can be selected from any filler material as may be suitable for use in reinforcing a polyolefin. The filler material can be selected from an inorganic filler material or an organic filler material. Fillers may include mineral fillers, pigments, a fiber, and the like.

Examples of mineral fillers or pigments include, but are not limited to, titanium dioxide, aluminium trihydroxide, magnesium dihydroxide, mica, kaolin, calcium carbonate, non-hydrated, partially hydrated, or hydrated fluorides, chlorides, bromides, iodides, chromates, carbonates, hydroxides, phosphates, hydrogen phosphates, nitrates, oxides, and sulphates of sodium, potassium, magnesium, calcium, and barium; zinc oxide, aluminium oxide, antimony pentoxide, antimony trioxide, beryllium oxide, chromium oxide, iron oxide, lithopone, boric acid or a borate salt such as zinc borate, barium metaborate or aluminium borate, mixed metal oxides such as aluminosilicate, vermiculite, silica including fumed silica, fused silica, precipitated silica, quartz, sand, and silica gel; rice hull ash, ceramic and glass beads, zeolites, metals such as aluminium flakes or powder, bronze powder, copper, gold, molybdenum, nickel, silver powder or flakes, stainless steel powder, tungsten, hydrous calcium silicate, barium titanate, silica-carbon black composite, functionalized carbon nanotubes, cement, fly ash, slate flour, bentonite, clay, talc, anthracite, apatite, attapulgite, boron nitride, cristobalite, diatomaceous earth, dolomite, ferrite, feldspar, graphite, graphene, carbon fiber, calcined kaolin, molybdenum disulfide, perlite, pumice, pyrophyllite, sepiolite, zinc stannate, zinc sulfide or wollastonite.

Examples of fibers include, but are not limited to, natural fibers such as wood flour, wood fibers, cotton fibers, cellulosic fibers or agricultural fibers such as wheat straw, hemp, flax, kenaf, kapok, jute, ramie, sisal, henequen, corn fibre or coir, or nut shells or rice hulls, or synthetic fibers such as polyester fibers, aramid fibers, nylon fibers, or glass fibers.

Examples of organic fillers include, but are not limited to, lignin, starch or cellulose and cellulose-containing products, or plastic microspheres of polytetrafluoroethylene or polyethylene. The filler can be a solid organic pigment such as those incorporating azo, indigoid, triphenylmethane, anthraquinone, hydroquinone or xanthine dyes.

In one embodiment, the filler material comprises at least one filler material selected from a glass fiber, talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, wheat straw, flax, hemp, kenaf, nut shells, rice hulls, cotton fibers, wood pulps, stem or vegetable fibers, wood flours, starch, waste papers, cartons, cellulosic cloth or a combination of two or more thereof.

The filler material is treated with an acrylic functional silane. The acrylic functional silane comprises an acrylic functional group CH2═CH—C(O)—. In one embodiment, the acrylic functional group is an acryloxy group. In one embodiment, the acrylic functional group is an acrylamido functional group.

In one embodiment, the acrylic functional silane is a compound of the formula:

CH₂═CH—C(O)—X—R¹—Si—R²(R³)_{3-b}

where:

### X is O or N(R⁴);

R¹ is independently a divalent group selected from straight chain alkyl containing from 1 to 20 carbon atoms, a branched chain alkyl containing from 3 to 20 carbon atoms, a cycloalkyl containing from 5 to 20 carbon atoms, an alkenyl containing from 2 to 20 carbon atoms, an aryl group containing from 6 to 20 carbon atoms or aralkyl containing from 7 to 20 carbon atoms;
R² is (OR⁵)_{b} where R⁵ is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl containing from 2 to 12 carbon atoms, an aryl group containing 6 carbon atoms, or aralkyl containing from 7 to 12 carbon atoms, a straight chain alkyl containing 2 to 12 carbon atoms and a hydroxyl group or a branched chain alkyl containing 3 to 6 carbon atoms and a hydroxyl group, an alkyl group containing at least one oxygen atom having the structure —R⁶—(OCH₂CH₂)ₘ(OCH₂CH(CH₃))ₙOR⁷ or is a divalent group formed from two R⁵ groups being bonded together through a covalent bond, with the provisos that (i) if two R⁵ groups are bonded together, then b is 2 or 3 and (ii) the sum of m+n is from 1 to 20;
b is 1, 2, or 3;
each R³ is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl group containing from 2 to 12 carbon atoms, an aryl group containing 6 carbon atoms or aralkyl group containing from 7 to 12 carbon atoms;
R⁴ is independently H, is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl group containing from 2 to 12 carbon atoms, an aryl group containing 6 carbon atoms or aralkyl group containing from 7 to 12 carbon atoms;
R⁶ is divalent group selected from straight chain alkyl containing from 1 to 10 carbon atoms, a branched chain alkyl containing from 3 to 10 carbon atoms, a cycloalkyl containing from 5 to 10 carbon atoms;
R⁷ is a monovalent group selected from straight chain alkyl containing from 1 to 18 carbon atoms, a branched chain alkyl containing from 3 to 18 carbon atoms, a cycloalkyl containing from 5 to 18 carbon atoms, an alkenyl containing from 2 to 18 carbon atoms, an aryl group containing from 6 to 18 carbon atoms, aralkyl containing from 7 to 18 carbon atoms or hydrogen, or is a divalent group selected from an alkyl containing from 1 to 10 carbon atoms, a cycloalkyl containing from 5 to 10 carbon atoms or phenyl.

In embodiments where two R³ groups are bonded together, examples of suitable divalent groups formed from combining two R³ groups include, but are not limited to, a divalent group having 2 to 12 carbon atoms. In one embodiment where two R³ groups are bonded together, the groups may be selected from —CH₂CH₂—, —CH₂CH₂CH₂—, —CH₂CH(CH₃)CH₂—, —CH₂CH₂CH(CH₃)—, and the like.

In one embodiment, X is O, R¹ is a C1-C10 straight chain alkyl, or a C3-C10 branched chain alkyl, and b is 1, 2, or 3. In one embodiment, b is 3 such that the acrylic functional silane is a trialkoxy silane. In one embodiment, R⁴ is a C1-C12 straight chain alkyl or a C3-C12 branched chain alkyl. In one embodiment, R⁴ is a C1-C4 straight chain alkyl. In one embodiment, R⁴ is a methyl group.

Non-limiting examples of the acrylic functional silane for treating the filler include, for example, 3-acryloxypropyl triethoxysilane, 3-acryloxypropyl trimethoxysilane, 3-acryloxypropylmethyldimethoxysiIane, 3-acryloxypropylmethyldiethoxysilane, 3-acryIoxypropyldiethylmethoxysiIane, 3-acryloxypropyldimethylethoxysilane, 3-acryloxymethyltriethoxysilane, 3-acryloxymethyltrimethoxysilane, and the like.

The acrylic function silane may be present in the treated filler in an amount of from about 0.01 wt. % to about 20 wt. % , from about 0.05 wt. % to about 15 wt. %, from about 0.1 wt. % to about 10 wt. %, from about 1 wt. % to about 7.5 wt. %, or from about 2 wt. % to about 5 wt. % based on the total weight of the treated filler.

The treated filler can be prepared by any suitable method. In one embodiment, the treated filler is prepared by treating a filler material with a selected acrylic functional silane such as by mixing a filler material with the acrylic functional silane and then drying the filler material for a sufficient period of time at an elevated temperature to provide the treated filler. In one embodiment, the mixture of the filler material and the acrylic functional silane can be dried in a convection oven for a period of 10-24 hours at a temperature of from about 75° C. to about 100° C.

In another embodiment, the treated filler is formed in-situ during compounding of the polyolefin and the filler. In this operation, the filler and acrylic functional silane are separately compounded with the polyolefin resin.

The treated filler is present in the composition in an amount of from about 0.1 wt. % to about 99 wt. %, from about 0.5 wt. % to about 95 wt. %, from about 1 wt. % to about 90 wt. %, from about 5 wt. % to about 80 wt. %, from about 10 wt. % to about 75 wt. %, from about 15 wt. % to about 60 wt. %, from about 20 wt. % to about 50 wt. %, or from about 25 wt. % to about 40 wt. % based on the total weight of the composition.

It will be appreciated that, in addition to the treated fillers, the compositions may also contain untreated fillers. The untreated fillers can be any suitable filler. The untreated filler can be selected from the filler materials described with respect to producing the treated filler. For the sake of brevity, the specific examples of suitable fillers are not repeated. In one embodiment, the untreated filler material comprises at least one filler material selected from a glass fiber, talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, wheat straw, flax, hemp, kenaf, nut shells, rice hulls, cotton fibers, wood pulps, stem or vegetable fibers, wood flours, starch, waste papers, cartons, cellulosic cloth or a combination of two or more thereof.

In one embodiment, the composite composition comprises a silane additive. In one embodiment, the silane additive is selected from an acryloxy/acrylamido silane of the formula:

CH₂═CH—C(O)—X′—R^{1′}—Si—R^{2′}(R^{3′})_{3-b′}

where:

### X′ is O or N(R^{4′});

R^{1′} is independently a divalent group selected from straight chain alkyl containing from 1 to 10 carbon atoms, a branched chain alkyl containing from 3 to 10 carbon atoms, a cycloalkyl containing from 5 to 10 carbon atoms, an alkenyl containing from 2 to 10 carbon atoms, an aryl group containing from 6 to 10 carbon atoms or aralkyl containing from 7 to 10 carbon atoms;
R^{2′} is (OR^{5′})_{b′} where R^{5′} is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl containing from 2 to 12 carbon atoms, an aryl group containing 6 carbon atoms, aralkyl containing from 7 to 12 carbon atoms, a straight chain alkyl containing 2 to 12 carbon atoms and a hydroxyl group or a branched chain alkyl containing 3 to 6 carbon atoms and a hydroxyl group, or an alkyl group containing at least one oxygen atom having the structure —R^{6′}—(OCH₂CH₂)_{m′}(OCH₂CH(CH₃))_{n′}OR^{7′} or is a divalent group formed from two R^{5′} groups being bonded together through a covalent bond, with the provisos that (i) if two R^{5′} groups are bonded together, then b is 2 or 3 and (ii) the sum of m′+n′ is from 1 to 20;
b′ is 1, 2, or 3;
each R^{3′} is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl group containing from 2 to 12 carbon atoms, an aryl group containing 6 carbon atoms or aralkyl group containing from 7 to 12 carbon atoms;
R^{4′} is independently H, is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl group containing from 2 to 12 carbon atoms, an aryl group containing 6 carbon atoms or aralkyl group containing from 7 to 12 carbon atoms;
R^{6′} is divalent group selected from straight chain alkyl containing from 1 to 10 carbon atoms, a branched chain alkyl containing from 3 to 10 carbon atoms, a cycloalkyl containing from 5 to 10 carbon atoms;
R^{7′} is a monovalent group selected from straight chain alkyl containing from 1 to 18 carbon atoms, a branched chain alkyl containing from 3 to 18 carbon atoms, a cycloalkyl containing from 5 to 18 carbon atoms, an alkenyl containing from 2 to 18 carbon atoms, an aryl group containing from 6 to 18 carbon atoms, aralkyl containing from 7 to 18 carbon atoms or hydrogen, or is a divalent group selected from an alkyl containing from 1 to 10 carbon atoms, a cycloalkyl containing from 5 to 10 carbon atoms or phenyl..

Non-limiting examples of acrylic functional silanes as the silane additive include, for example, 3-acryloxypropyl triethoxysilane, 3-acryloxypropyl trimethoxysilane, 3-acryloxypropylmethyldimethoxysilane, 3-acryloxypropylmethyldiethoxysilane, 3-acryloxypropyldiethylmethoxsilane, 3-acryloxypropyldimethylethoxysilane, 3-acryloxymethyltriethoxysilane, 3-acryloxymethyltrimethoxysilane, and the like.

The silane additive can be present in the composition in an amount of from about 0.01wt % to about 20 wt. %, from about 0.5 wt. % to about 15 wt. %, from about 1 wt. % to about 10 wt. %, or from about 2 wt. % to about 5 wt. % based on the total weight of the composition.

In one embodiment, the polyolefin composition consists essentially of a polyolefin resin, and a filler treated with an acrylic functional silane. In one embodiment, the polyolefin composition consists essentially of a polyolefin, a filler treated with an acrylic functional silane, and a silane additive such as, for example, an acrylic functional silane. In embodiments wherein the polyolefin consists essentially of the polyolefin resin, the filler treated with an acrylic functional silane, and optionally a silane additive, the respective components can be selected from any of the materials previously described with respect to those components and can be present in the amounts previously described with respect to those components.

The composition may include any other additives as may be suitable for polyolefin composite materials. Other suitable additives include, but are not limited to, a peroxide, an antioxidant, a lubricant, a pigment, and the like. The other additives can be added to the composition in an amount of from about 0% to about 25%, from about 0.01% to about 25%; from about 0.1% to about 20%; from about 0.5% to about 15%; from about 1% to about 10%; from about 2.5% to about 7.5%; or from about 3% to about 5% based on the total weight of the composition. Such additives are optional and need not be present in the compositions.

Examples of suitable peroxides include, but are not limited to, hydroperoxides, carboxylic peroxyesters, peroxyketals, dialkyl peroxides and diacyl peroxides, ketone peroxides, diaryl peroxides, aryl-alkyl peroxides, peroxy dicarbonates, peroxyacids, acyl alkyl sulfonyl peroxides and monoperoxydicarbonates. Examples of preferred peroxides include dicumyl peroxide, 2,5-dimethyl-2,5-di-(tert-butylperoxy)hexane, di-tert-butyl peroxide, 2,5-dimethyl-2,5-di-(tert-butylperoxy)hexyne-3 ,3,6, 9-triethyl-3 ,6,9- trimethyl-1,4, 7-triperoxonane, benzoyl peroxide, 2,4-dichlorobenzoyl peroxide, tert-butyl peroxyacetate, tert-butyl peroxybenzoate, tert-amylperoxy-2-ethylhexyl carbonate, tert-butylperoxy-3 ,5,5-trimethylhexanoate, 2,2-di (tert-butylperoxy)butane, tert-butylperoxy isopropyl carbonate, tert-buylperoxy-2-ethylhexyl carbonate, butyl 4,4-di(tert-buylperoxy)valerate, di-tert-amyl peroxide, tert-butyl peroxy pivalate, tert-butyl-peroxy-2-ethyl hexanoate, di(tertbutylperoxy)cyclohexane, tertbutylperoxy-3,5,5-trimethylhexanoate, di(tertbutylperoxyisopropyl)benzene, cumene hydroperoxide, tert-butyl peroctoate, methyl ethyl ketone peroxide, tert-butyl α-cumyl peroxide, 2,5-dimethyl-2,5-di(peroxybenzoate)hexyne-3, 1,3- or 1,4-bis(t-butylperoxyisopropyl)benzene, lauroyl peroxide, tert-butyl peracetate, and tert-butyl perbenzoate. Examples of azo compounds are azobisisobutyronitrile and dimethylazodiisobutyrate. The above radical initiators can be used alone or in combination of at least two of them.

The antioxidant is not particularly limited and can be selected as desired for a particular purpose or intended application. Examples of suitable antioxidants include, but are not limited to, include tris(2,4-di-tert-butylphenyl)phosphite sold commercially under the trade mark Ciba Irgafos®168, tetrakis [methylene-3-(3,5-di-tert-butyl-4-hydroxyphenyl-propionate)] methane processing stabilizer sold commercially under the trade mark Ciba Irganox®1010 and 1,3,5-trimethyl-2,4,6-tris(3,5-di-tert-butyl-4-hydroxy benzyl)benzene sold commercially under the trade mark Ciba Irganox®1330. It may also be desired that the crosslinked polymer contains a stabiliser against ultraviolet radiation and light radiation, for example a hindered amine light stabiliser such as a 4-substituted-1,2,2,6,6-pentamethylpiperidine, for example those sold under the trade marks Tinuvin 770, Tinuvin 622, Uvasil 299, Chimassorb 944 and Chimassorb 119.

In one embodiment, the polyolefin composition is free of an antioxidant. Applicant's have found that the employing the fillers treated with acrylic functional silanes in a polyolefin composition allows for greatly simplifying polyolefin compositions such that materials such as antioxidants are not required. In compositions employing grafted polyolefin additives (e.g., anhydride grafted polyolefin or silane grafted polyolefin) antioxidants may be required to stabilize the composition and prevent polymer degradation. That is not necessary in the present compositions.

The polyolefin composition is produced by compounding the polyolefin and the treated filler to form a composite composition. The polyolefin and filler components, along with any other desired additives, can be compounded to provide the composite composition by mixing and compounding at a temperature of from about 150 to about 250° C., about 180 to about 240° C., or from about 200° C. to about 230° C. for a sufficient time to form the composite. The compounding step can, in embodiments be from about 0.5 to about 60 minutes, about 1 minute to about 45 minutes, or from about 5 minutes to about 30 minutes. Compounding can be accomplished in any suitable manner such as by kneading carried out with any conventionally used device such as a blender, a kneader, a roll mixer, a Banbury mixer, or a uniaxial or biaxial extruder. The composite composition can be used after production and fed directly to an extruder to be extruded to any desired final extruded product. Alternatively, the kneaded composition may be shaped into pellets or particles for the purpose of storage and subsequent use in an extrusion process.

The present polyolefin composition provides a simpler formulation and simpler processing compared to the current, conventional processes. Applicant has found that a composition comprising a polyolefin and the treated filler alone may be sufficient to provide a molded polyolefin material that exhibits improved strength properties (e.g., tensile strength, impact strength, and the like) without the addition of other additives such as lubricants, antioxidants, etc. Those additives can be added if desired, but they are not necessary. The present compositions also do not require the use of materials such as grafted polypropylene to develop interfacial bonding. In embodiments, the composition is free of a grafted polyolefin such as, for example a polyolefin grafted with a functional group such as, for example, an anhydride, a silane, or other functional chemical groups. Without being bound to any particular theory, the present compositions utilize the inherent instability of polyolefins during compounding, and the acrylic functionality is believed to efficiently arrest free radicals generated during beta-scission and a covalent bond is concurrently formed during compounding in the formation of the composite.

The polyolefin composition according to the present invention may be used for the production of any extruded articles. They can be processed using any suitable extrusion method, process, or equipment. Extrusion can be carried out using a single screw or twin screw extruder. As previously described the present polyolefin compositions can be used directly following the production of the composition, or they can be formed into pellets or particles for later use. Examples of articles that can be made using the present polyolefin compositions include, but are not limited to, electrically insulating materials, domestic electric appliances, industrial parts, automobile interior and exterior parts, household parts, and construction and housing materials. Examples of shaped articles include, but are not limited to, console boxes, door trims, armrests, grip knobs, ceiling parts, housings, pillars, mud guards, bumpers, fenders, back doors, fan shrouds, baseboards, surface decorative boards, door materials, exterior wall materials, interior wall materials, counter materials, window frames, handrails, knobs, pillars, floor materials, earthquake-proofing materials, ceiling materials, concrete panels, backing materials, scaffolding materials, shielding materials, sound-proofing materials, furniture materials, shelves, cooking materials, water-proofing materials and flashing boards.

The present invention may be further understood with respect to the following examples. The examples are intended to illustrate aspects and embodiments of the invention, and are not necessarily intended to limit the invention.

### EXAMPLES

Polyolefin compositions were prepared by compounding the respective components listed in Table 1. The treated silica in the Examples are prepared by treating silica with 2% of A-1100 available from Momentive Performance Materials Inc. (Comparative Example 1) or 2% of an acryloxy silane (Example 1 & Example 2) and drying the material overnight in a convection oven at 80° C. The respective compositions listed in Table 1 were compounded using a Coperion 18mm twin screw extruder at 220° C. and then formed into pellets. The pellets were dried in a convection oven overnight at a temperature of 80° C. Specimens were prepared by injection molding the composite polypropylene pellets.

The tensile strength and notched impact strength of the molded specimens were evaluated. Tensile strength is tested according to ASTM D638 “Standard Test Method for Tensile Properties of Plastics.” Notched impact strength is determined using methods recognized in the field of polymer science, for example as described in ISO 180/1A, “Plastics-Determination of Izod impact strength”.

The formulations for the respective compositions are provided in Table 1.

TABLE 1

| | Comparative | | |
|---|---|---|---|
| | Example 1 | Example 1 | Example 2 |
| Ingredient | wt % | Wt % | Wt % |
| PP resin | 63.3 | 70 | 70 |
| Filler | 30% | 30% | 30% |
| | aminopropyl- | acryloxypropyl- | acryloxypropyl- |
| | triethoxy silane | trimethoxysilane | trimethoxysilane |
| | treated SiO2 | treated SiO2 | treated SiO2 |
| Silane | — | — | 2% |
| | | | acryloxypropyl- |
| | | | trimethoxysilane |
| Anhydride | 5 | — | — |
| grafted | | | |
| polypropylene | | | |
| Lubricant | 0.3 | — | — |
| Primary | 0.2 | — | — |
| antioxidant | | | |
| Auxiliary | 0.1 | — | — |
| antioxidant | | | |

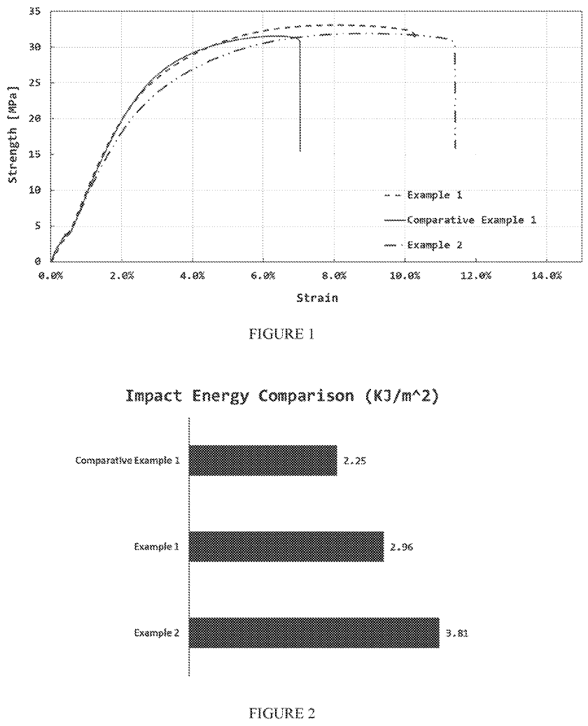

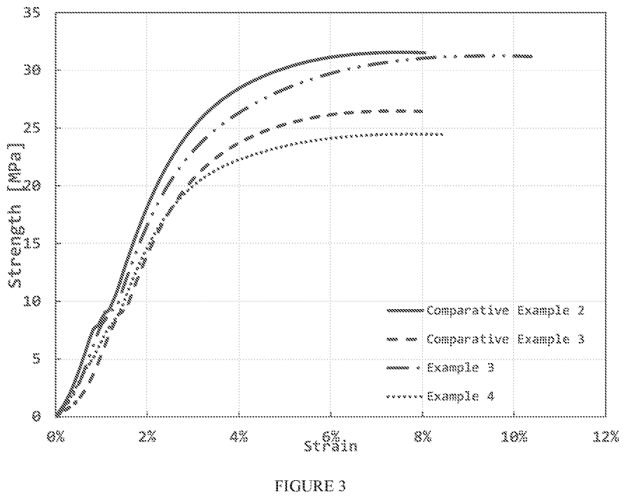

FIGS. 1 and 2 show the results of the tensile property and impact testing of the molded specimens. FIG. 1 shows that Examples 1 and 2 employing the fillers treated with an acryloxy silane exhibit improved strength at higher levels of strain compared to Comparative Example 1, which is a conventional formulation employing an aminosilane treated filler. FIG. 2 shows that employing a treated filler in accordance with the present technology also exhibit improved impact properties, with Examples 1 and 2 showing an increase in impact strength of 32% and 70%, respectively, compared to Comparative Example 1. Those skilled in the art will recognize that any improvement above 15% is significant. Additionally, FIGS. 1 and 2 show that adding a separate acryloxy/acrylamido silane additive in addition to the treated fillers treated with an acryloxy/acrylamido functional silane can further improve the properties of the composite materials.

### Example 3

Polyolefin compositions were prepared by compounding the respective components listed in Table 2. The treated silica in the Examples are prepared by treating silica with 2% of A-1100 available from Momentive Performance Materials Inc. (Comparative Example 2); 2% of A-174 available from Momentive Performance materials Inc. (Comparative Example 3) or 2% of an acryloxy silane (Examples 3 and 4) and drying the material overnight in a convection oven at 80 ° C. The respective compositions listed in Table 2 were compounded using an Xplore micro extruder at 220° C., and injection molded into tensile specimens using an Xplore micro injection molder.

The tensile strength of the molded specimens were evaluated. Tensile strength is tested according to ASTM D638 “Standard Test Method for Tensile Properties of Plastics.” The formulations for the respective compositions are provided in Table 2.

TABLE 2

| | Comparative | Comparative | | |
|---|---|---|---|---|
| | Example 2 | Example 3 | Example 3 | Example 4 |
| Ingredients | wt % | Wt % | Wt % | Wt % |
| PP resin | 63.3 | 70 | 70 | 70 |
| Silica | 30% | 30% | 30% | 30% |
| | aminopropyl- | methacryloxypropyl- | acryloxypropyl- | acryloxypropyl- |
| | triethoxy silane | trimethoxysilane | trimethoxysilane | trimethoxysilane |
| | treated SiO2 | treated SiO2 | treated SiO2 | treated SiO2 |
| Anhydride grafted | 5 | — | — | |
| polypropylene | | | | |
| Lubricant | 0.3 | — | — | 0.3 |
| Primary antioxidant | 0.2 | — | — | 0.2 |
| Auxiliary antioxidant | 0.1 | — | — | 0.1 |

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a composite polyolefin composition. Modifications may occur to those skilled in the art and to those who may make and use the invention. The disclosed embodiments are merely for illustrative purposes and not intended to limit the scope of the invention or the subject matter set forth in the claims.

What is claimed is:

1. A polyolefin composition comprising (i) a polyolefin resin, and (ii) a filler treated with an acrylic functional silane, wherein the acrylic functional silane is of the formula:
CH₂═CH—C(O)—X—R¹—Si—R²(R³)_{3-b}
where:
X is O or N(R⁴);
R¹ is independently a divalent group selected from straight chain alkyl containing from 1 to 20 carbon atoms, a branched chain alkyl containing from 3 to 20 carbon atoms, a cycloalkyl containing from 5 to 20 carbon atoms, an alkenyl containing from 2 to 20 carbon atoms, an aryl group containing from 6 to 20 carbon atoms or aralkyl containing from 7 to 20 carbon atoms;
R² is (OR⁵)_{b} where R⁵ is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl containing from 2 to 12 carbon atoms, an aryl group containing 6 carbon atoms, or aralkyl containing from 7 to 12 carbon atoms, a straight chain alkyl containing 2 to 12 carbon atoms and a hydroxyl group or a branched chain alkyl containing 3 to 6 carbon atoms and a hydroxyl group, an alkyl group containing at least one oxygen atom having the structure —R⁶—(OCH₂CH₂)ₘ(OCH₂CH(CH₃))ₙOR⁷ or is a divalent group formed from two R⁵ groups being bonded together through a covalent bond, with the provisos that (i) if two R⁵ groups are bonded together, then b is 2 or 3 and (ii) the sum of m+n is from 1 to 20;
b is 1, 2, or 3;
each R³ is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl group containing from 2 to 12 carbon atoms, an aryl group containing 6 carbon atoms or aralkyl group containing from 7 to 12 carbon atoms;
R⁴ is independently H, is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl group containing from 2 to 12 carbon atoms, an aryl group containing 6 carbon atoms or aralkyl group containing from 7 to 12 carbon atoms;
R⁶ is divalent group selected from straight chain alkyl containing from 1 to 10 carbon atoms, a branched chain alkyl containing from 3 to 10 carbon atoms, a cycloalkyl containing from 5 to 10 carbon atoms;
R⁷ is a monovalent group selected from straight chain alkyl containing from 1 to 18 carbon atoms, a branched chain alkyl containing from 3 to 18 carbon atoms, a cycloalkyl containing from 5 to 18 carbon atoms, an alkenyl containing from 2 to 18 carbon atoms, an aryl group containing from 6 to 18 carbon atoms, aralkyl containing from 7 to 18 carbon atoms or hydrogen, or is a divalent group selected from an alkyl containing from 1 to 10 carbon atoms, a cycloalkyl containing from 5 to 10 carbon atoms or phenyl;
wherein the composition is free of a polyolefin additive having a functional group bonded to a polyolefin.

2. The polyolefin composition of claim 1, wherein the filler treated with an acrylic functional silane comprises the acrylic functional silane in an amount of from about 0.01 wt. % to about 20 wt. % based on the total weight of the filler.

3. The polyolefin composition of claim 1, wherein the filler treated with an acrylic functional silane comprises the acrylic functional silane in an amount of from about 1 wt. % to about 7.5 wt. % based on the total weight of the filler

4. The polyolefin composition of claim 1, wherein the filler treated with an acrylic functional silane comprises the acrylic functional silane in an amount of from about 2 wt. % to about 5 wt. % based on the total weight of the filler

5. The polyolefin composition of claim 1, wherein the filler is selected from at least one of titanium dioxide, aluminium trihydroxide, magnesium dihydroxide, mica, kaolin, calcium carbonate, non-hydrated, partially hydrated, or hydrated fluorides, chlorides, bromides, iodides, chromates, carbonates, hydroxides, phosphates, hydrogen phosphates, nitrates, oxides, and sulphates of sodium, potassium, magnesium, calcium, and barium; zinc oxide, aluminium oxide, antimony pentoxide, antimony trioxide, beryllium oxide, chromium oxide, iron oxide, lithopone, boric acid or a borate salt such as zinc borate, barium metaborate or aluminium borate, mixed metal oxides such as aluminosilicate, vermiculite, silica including fumed silica, fused silica, precipitated silica, quartz, sand, and silica gel; rice hull ash, ceramic and glass beads, zeolites, metals such as aluminium flakes or powder, bronze powder, copper, gold, molybdenum, nickel, silver powder or flakes, stainless steel powder, tungsten, hydrous calcium silicate, barium titanate, silica-carbon black composite, functionalized carbon nanotubes, cement, fly ash, slate flour, bentonite, clay, talc, anthracite, apatite, attapulgite, boron nitride, cristobalite, diatomaceous earth, dolomite, ferrite, feldspar, graphite, graphene, carbon fiber, calcined kaolin, molybdenum disulfide, perlite, pumice, pyrophyllite, sepiolite, zinc stannate, zinc sulfide or wollastonite, wood flour, wood fibers, cotton fibers, wheat straw, hemp, flax, kenaf, kapok, jute, ramie, sisal, henequen, corn fibre or coir, or nut shells or rice hulls, polyester fibers, aramid fibers, nylon fibers, glass fibers, lignin, starch, cellulose or cellulose-containing products, plastic microspheres of polytetrafluoroethylene or polyethylene, azo dyes, indigoid dyes, triphenylmethane dyes, anthraquinone dyes, hydroquinone dyes, or xanthine dyes.

6. The composition of claim 1, wherein the filler is selected from calcium hydroxide, barium sulfate, mica, calcium silicate, clay, kaolin, silica, alumina, wollastonite, magnesium carbonate, magnesium hydroxide, titanium oxide, zinc oxide, zinc sulfate, or a combination of two or more thereof.

7. The composition of claim 1, wherein the filler is selected from silica.

8. The polyolefin composition of claim 1, wherein the filler treated with an acrylic functional silane is present in an amount of from about 0.01 wt. % to about 99 wt. % based on the total weight of the polyolefin composition.

9. The polyolefin composition of claim 1, wherein the filler treated with an acrylic functional silane is present in an amount of from about 20 wt. % to about 50 wt. % based on the total weight of the polyolefin composition.

10. The polyolefin composition of claim 1, wherein the polyolefin is selected from a polymer of an olefin having from 2 to 18 carbon atoms.

11. The polyolefin composition of claim 1, wherein the polyolefin is selected from a polypropylene, a polyethylene, polybutylene, or a mixture of two or more thereof.

12. The polyolefin composition of claim 1, wherein the polyolefin is present in an amount of from about 10 wt. % to about 99.9 wt. % based on the total weight of the polyolefin composition.

13. The polyolefin composition of claim 1 further comprising (iii) a silane additive.

14. The polyolefin composition of claim 13, wherein the silane additive is selected from an acrylic functional silane selected from an acrlyoxy functional silane, an acrylamido functional silane, or a combination thereof.

15. The polyolefin composition of claim 13, wherein the silane additive (iii) is of the formula:
CH₂═CH—C(O)—X′—R^{1′}—Si—R^{2′}(R^{3′})_{3-b′}
where:
X′ is O or N(R^{4′});
R^{1′} is independently a divalent group selected from straight chain alkyl containing from 1 to 10 carbon atoms, a branched chain alkyl containing from 3 to 10 carbon atoms, a cycloalkyl containing from 5 to 10 carbon atoms, an alkenyl containing from 2 to 10 carbon atoms, an aryl containing from 6 to 10 carbon atoms or aralkyl containing from 7 to 10 carbon atoms;
R^{2′} is (OR^{5′})_{b′} where R^{5′} is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl containing from 2 to 12 carbon atoms, an aryl containing 6 carbon atoms, aralkyl containing from 7 to 12 carbon atoms, a straight chain alkyl containing 2 to 12 carbon atoms and a hydroxyl or a branched chain alkyl containing 3 to 6 carbon atoms and a hydroxyl, or an alkyl containing at least one oxygen atom having the structure —R^{6′}—(OCH₂CH₂)_{m′}(OCH₂CH(CH₃))_{n′}OR^{7′} or is a divalent group formed from two R^{5′} groups being bonded together through a covalent bond, with the provisos that (i) if two R^{5′} groups are bonded together, then b is 2 or 3 and (ii) the sum of m′+n′ is from 1 to 20;
b′ is 1, 2, or 3;
each R³′ is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl containing from 2 to 12 carbon atoms, an aryl containing 6 carbon atoms or aralkyl containing from 7 to 12 carbon atoms;
R⁴ is independently H, is independently a monovalent group selected from a straight chain alkyl containing from 1 to 12 carbon atoms, a branched chain alkyl containing from 3 to 12 carbon atoms, a cycloalkyl containing from 5 or 6 carbon atoms, an alkenyl containing from 2 to 12 carbon atoms, an aryl containing 6 carbon atoms or aralkyl containing from 7 to 12 carbon atoms;
R^{6′} is divalent group selected from straight chain alkyl containing from 1 to 10 carbon atoms, a branched chain alkyl containing from 3 to 10 carbon atoms, a cycloalkyl containing from 5 to 10 carbon atoms;
R^{7′} is a monovalent group selected from straight chain alkyl containing from 1 to 18 carbon atoms, a branched chain alkyl containing from 3 to 18 carbon atoms, a cycloalkyl containing from 5 to 18 carbon atoms, an alkenyl containing from 2 to 18 carbon atoms, an aryl containing from 6 to 18 carbon atoms, aralkyl containing from 7 to 18 carbon atoms or hydrogen, or is a divalent group selected from an alkyl containing from 1 to 10 carbon atoms, a cycloalkyl containing from 5 to 10 carbon atoms or phenyl.

16. The polyolefin composition of claim 1, wherein the composition is in the form of a pellet or particle.

17. The polyolefin composition of claim 1 consisting essentially of the polyolefin resin (i), the filler treated with an acrylic functional silane (ii), and optionally the silane additive (iii).

18. The polyolefin composition of claim 1 further comprising at least one additive selected from a peroxide, an antioxidant, a lubricant, a pigment, or a combination of two or more thereof.

19. A molded article formed from the polyolefin composition of claim 1.

20. A method of making a molded article comprising extruding the polyolefin composition of claim 1 into a molded article.

21. A method of making a polyolefin composition of claim 1 comprising: compounding a polyolefin with a filler treated with an acrylic functional silane.
